(19) United States
(12) Patent Application Publication
(10) Pub. No.: US 2025/0291520 A1
(43) Pub. Date: Sep. 18, 2025

(54) System and Method for Provisioning a Cloud Tape Library

(71) Applicant: Geyser Data, Inc., Tustin, CA (US)

(72) Inventor: Nelson Nahum, Tustin, CA (US)

(73) Assignee: Geyser Data, Inc., Tustin, CA (US)

(21) Appl. No.: 19/075,780

(22) Filed: Mar. 10, 2025

Related U.S. Application Data
(60) Provisional application No. 63/564,111, filed on Mar. 12, 2024.

(51) Int. Cl. G06F 3/06

(52) U.S. Cl. CPC G06F 3/0686; G06F 3/0604; G06F 3/0637

(57) ABSTRACT

A Cloud Tape Library (CTL) system and methods are disclosed. The CTL system includes a virtual tape library hosted in a cloud environment. The CTL system may be optimized for read operations that includes a disk caching layer for initial data storage, and one or more physical tape libraries for long-term data archiving. The CTL system may place all data associated with a particular user/user device or specific workload within a dedicated tape cartridge. Tape cartridges dedicated to a single user may significantly improve data retrieval times and may improve security by isolating user data from the data of other users. Multiple users may perform read/write operations on the CTL system in parallel. Users may set rules for data organization to control organization of data between tape cartridges for fast retrieval.

### PRIORITY

This application claims the benefit of priority to U.S. Provisional Patent Application 63/564,111 entitled “SYSTEM AND METHOD FOR PROVISIONING A CLOUD TAPE LIBRARY WITH TAPE ALLOCATION OPTIMIZED FOR READ OPERATIONS” filed Mar. 12, 2024, incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of data storage technologies. More particularly, the present disclosure relates to systems and methods for provisioning a cloud tape library.

### DESCRIPTION OF RELATED TECHNOLOGY

Tape libraries have traditionally been used to archive data, e.g., data that is not immediately needed by a user device, and provide archived data to the user device.

On-premises tape libraries have been used as a cost-effective long-term data storage method. On-premises tape libraries provide users with dedicated tapes they can directly write to or read from. Because on-premises tape libraries are single tenant and use dedicated tapes, the tapes may be mounted directly into the computer that is writing or reading directly the data from the tapes. This system has no penalty for retrieval of the data but does not allow for multi-user operation/multi-tenancy nor as operation as a service (e.g., as a pay-per-use cloud model). Data is typically stored sequentially, where the single tenant is sends multiple packets of data to the tape library that are placed on the tape in sequential order. Once a first tape is full, the next data is placed in the second tape 2 and so on.

More recently, cloud libraries have risen as a scalable and accessible data storage solution. Cloud libraries are multi-tenant and may operate as a service (e.g., provide a pay-per-use cloud service) for users. Unfortunately, existing cloud libraries do not provide dedicated tape cartridges for each customer and therefore they do not allow the tapes to be sent back to the user. Further, cloud libraries are not optimized for efficient read operations, making it costly for a user to get their data back.

These systems are configured to have multiple tenants writing data in parallel. A cache may be used to store data to be written to tape until the next tape becomes available, e.g., when a tape is full and swapped for a new tape. These cloud library systems are optimized for write operations (e.g., to act only as an archive). Data from multiple tenants is stored based on the time the data arrives. As a result, the data from one tenant is stored adjacent data of another tenant mixing in the same tape many small sections of multiple tenants. The result is a system that may perform write operations very quickly, but at the same time the data of every tenant is spread across multiple sections of tape and multiple tapes. When a tenant requests retrieval (e.g., a read operation) it may require skipping over large sections of data within a tape and mounting multiple tapes. Swapping tapes may take multiple minutes each time to mount. As a result, cloud libraries traditionally de-incentivize data retrievals. Because tapes have data from multiple tenants, they may not be returned to tenants.

### BRIEF DESCRIPTION OF THE DRAWINGS

FIG. 1 is an exemplary environmental diagram illustrating the architecture of a cloud tape library (CTL) system 100.

FIG. 2 depicts a ladder diagram 200 illustrating use of the cloud tape library system 100 for data storage and retrieval according to aspects of the present disclosure.

FIG. 3 is a logical block diagram of a disk caching layer 108, according to aspects of the present disclosure.

FIG. 4 is a logical block diagram of a tape library 110, according to aspects of the present disclosure.

### DETAILED DESCRIPTION

In the following detailed description, reference is made to the accompanying drawings which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

### Example Operation

The present disclosure addresses the need for an innovative storage solution that combines the scalability and multitenancy of cloud storage (with e.g., the commensurate ease of use, cost benefits, service-based/pay-per-usage model) with the cost-effective data storage of tapes/an on-premises tape library including dedicated tape cartridges and optimized/faster read operations.

According to aspects of the disclosure, a Cloud Tape Library (CTL) system is disclosed. The CTL system includes a virtual tape library hosted in a cloud environment. The CTL system may be optimized for enhanced read operations that includes cloud software for parameter configuration, a disk cache layer for initial data storage, and one or more physical tape libraries for long-term data archiving. The CTL system may place all data associated with a particular user/user device or specific workload within a dedicated physical tape cartridge. Tape cartridges dedicated to a single user may significantly improve data retrieval times and may improve security by isolating user data from the data of other users. The CTL system may offer secure, scalable, and cost-effective archival data storage, with a focus on optimizing read operations that may benefit users with substantial data retrieval needs such as users performing data analytics and artificial intelligence (AI) operations/training.

According to various aspects of the disclosure, the CTL system may include dedicated tape cartridges for individual users. The CTL system may support both standard Read/Write and WORM (Write Once, Read Many) cartridges. Data compression and encryption may be enabled or disabled based on customer preferences or operational requirements.

As a cloud-based solution, the CTL system may be scalable and be flexible for users by adapting to varying storage needs without the upfront (and ongoing maintenance) costs associated with on-premises hardware. A CTL system may use be used as a service/use a pay-per-use model, reducing both capital and operational expenditures of users. Users may access the CTL system via standard APIs (e.g., Amazon Web Services (AWS) Glacier and S3). The use of standard APIs may enable easy and seamless integration with cloud storage workflows.

According to various aspects of the disclosure, multiple users may create accounts at one or more cloud tape library. Users may be exclusively associated with particular tapes and additional metadata may be used to map the user's files to particular tapes. As the tapes may be dedicated to a user, the user may have full visibility into which tapes are associated with their account/theirs and the tapes can be ejected from the CTL system and returned to the user. A disk caching layer may act to cache and coordinate user data to allow multiple users to write in parallel. The disk caching layer may prioritize certain data (e.g., data associated with a currently mounted tape), placing all the data of a particular user into a tape before changing tapes and moving to flush data from another tenant to its tapes.

According to various aspects of the disclosure, the CTL system may be multi-tenant and be optimized for read operations. This combination of features may be achieved through intelligent data placement strategies (e.g., separate tape cartridge(s) for each CTL and data organization rules for each CTL), ensuring that data retrieval is both fast and efficient, improving on-premises tape libraries and cloud storage solutions.

In some examples, the “time to first byte read” of requested data in the CTL system may be a few minutes (e.g. a robot brings the tape to the drive to mount it, and getting to the physical location within the tape). After the first bytes are read, the CTL system may stream the following bytes at the read speed of the tape. By co-locating all the data of a particular user or a particular workload in the same tape cartridge, the CTL system can stream data much faster than placing small pieces of user data on different tapes.

In order to control how to organize the data written for a fast retrieval, the user may set rules for data organization based on, e.g., the Cloud Tape Library name, which may be translated to the storage data structure (e.g., bucket) name; the file extension/data type; file permissions; and user defined tags. These rules and the relevant metadata may be used by the disk cache layer to determine, in real time, which tape cartridges to write the data to and read the data from.

### System Architecture

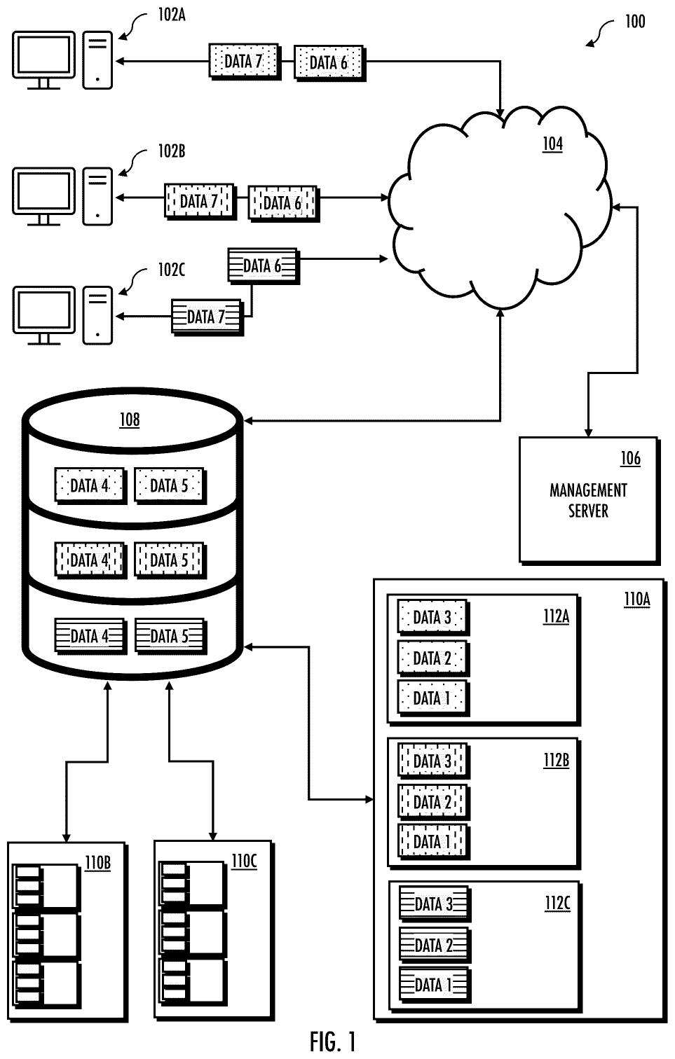

FIG. 1 is an exemplary environmental diagram illustrating the architecture of a cloud tape library (CTL) system 100. The Cloud Tape Library system 100 includes multiple user devices 102A, 102B, and 102C. User devices 102A-C may connect to the CTL system 100 via network 104. User devices 102 may create accounts with the cloud tape library system 100 via a management server 106. The CTL system 100 may include a disk caching layer 108 between the user devices 102 and tape libraries 110A, 110B, and 110C to cache data allowing multiple users to write in parallel to one or more tape library 110. Each tape library 110 of the CTL system 100 may include multiple tape cartridges 112A, 112B, and 112C to store user data (see e.g., data 1-7). Each tape cartridge 112 may be dedicated to a particular user, only storing data of that user (and no other user/user account of the CTL system 100).

The CTL system 100 may use a cloud-based infrastructure to simulate a traditional tape library with the dedicated tape cartridges and dedicated drives. By strategically placing all data related to a particular user account/user device 102 or workload on dedicated physical tape cartridges 112, the CTL system 100 may significantly reduce data retrieval times, enhancing user experience and security. The user may have full visibility into which tape cartridges are associated with their CTL/account (via interaction with the management server 106 or disk caching layer 108. Cloud tape libraries may be used as storage for user data both archival storage and as primary/active storage for data (e.g., large data sets).

User devices 102 may connect to the CTL system 100 via network 104. User devices 102 may interact with the CTL system 100 (including disk caching layer(s) 108) via standard cloud storage APIs. This may facilitate seamless integration with cloud environments. User devices 102 may manage their CTL(s) via a management user interface on the management server 106.

The management server 106 may facilitates account creation by multiple user devices 102 to create virtual cloud tape libraries, with dedicated tape cartridges 112 and additional metadata and rules to map the files/data to tape cartridges 112. The management server 106 may communicate with user devices 102 via a network 104. The management server 106 may communicate with the disk cache layer 108 via the network 104 or via a direct connection. The management server 106 may be a dedicated server (as shown). In other examples, the operations of the management server 106 may performed by other devices in the system (e.g., the disk caching layer 108 or the tape library 110) or be performed as a separate process/set of processes in a multi-tenant cloud server.

The disk caching layer 108 may control storage/retrieval of data at one or more tape library 110. In some examples, a CTL system 100 may include multiple disk caching layers 108. In some of these examples, each disk caching layer 108 is dedicated to a different tape library 110. In some examples, a disk caching layer 108 may cache data for multiple tape libraries 110. In other examples, multiple disk caching layers 108 may cache data for multiple tape libraries 110. In further examples, multiple disk caching layers 108 may cache data for a single tape library 110.

The disk caching layer 108 may cache data received from user devices 102, via the network 104. Storage of the user data may be prioritized by the disk caching layer 108. For example, all the data of a particular user account into a tape cartridge 112 on the tape library 110 before changing tape cartridges 112 and moving to flush the data from the next user to its tape cartridge(s) 112. The disk caching layer 108 may also prioritize read/write operations based on the data itself (metadata, size, etc.) or which specific tape data is to be written/read (e.g., among multiple tape cartridges 112 dedicated to a single user). The disk caching layer 108 may also arbitrate between read and write operations. In some examples, the disk caching layer 108 may prioritize read requests (while, e.g., caching data received from users). In some examples, the disk caching layer 108 may be on a separate physical server (as shown) that receives and controls one or more tape library 110. In other examples, the functions and hardware of the disk caching layer 108 may be a portion of the tape library 110 where data is pre-processed prior to storage and retrieval.

The disk caching layer 108 may employ one or more types of storage to cache data for permanent storage in the tape library 110. Storage solutions may include various types of random-access storage. As used herein, “random access” refers to the ability to access data at any arbitrary location or address in a storage medium without reading preceding data. As used herein, “random access storage” refers to storing data on a storage medium that uses random access for reading/retrieving data or otherwise traversing the storage medium. Data may be accessed in a random-access storage device quickly/almost instantly. Data may be retrieved in constant time and/or with direct addressing (e.g., via an index or pointer). (e.g., with constant time retrieval) may Examples include in-memory storage (e.g., Random Access Memory (RAM)), disk-based storage (e.g., hard disk drives (HDD)), and solid-state storage (e.g., solid state drive (SSD)).

The tape library 110 may include one or more tape cartridges 112 to store data received from the disk caching layer 108. Tape cartridges 112 are mounted into one or more drives for reading and writing data. The tape library 110 may have fewer tape drives than tape cartridges 112. Tape cartridges 112 may be unmounted and removed from a drive so other tape cartridges 112 may use the drive and be read from or written to.

Tape cartridges 112 are a removable data storage device that contains a long strip of magnetic tape used for sequential data storage. Data may be stored on the magnetic tape. Tape cartridges 112 may include read/write and write-once-read-many (WORM) tape cartridges. As used herein, “sequential access” refers to methods of accessing data where data is read in order, e.g., from the beginning of the sequential storage device. As used herein, “sequential data storage” refers to storing data on a storage medium that uses sequential access for reading/retrieving data or otherwise traversing the storage medium.

For example, hard disk drives (used in the disk cache layer 108) may take a few milliseconds for the read/write head to change to a different position on the disk. Tape cartridges 112 in the tape library 110 may take minutes for the read/write head to travel to another location on the tape cartridge 112. This is why, for caching solutions that receive data in an unordered/random fashion, hard disk drives (or other random-access storage) may be more efficient than tape cartridges 112 (or other sequential access storage). Tape cartridges 112 may be used for storage despite being limited by sequential access because of a high capacity (e.g., multiple terabytes of data), have long term durability (e.g., data may last decades without degrading), and be lower cost than similar-sized random access storage devices.

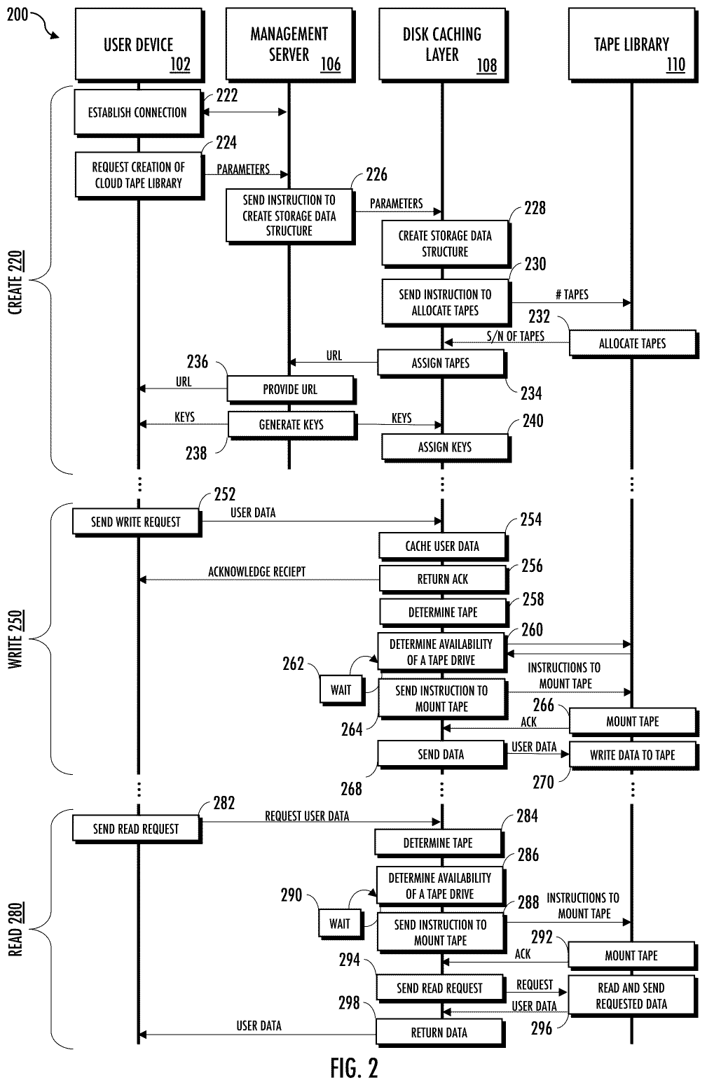

FIG. 2 depicts a ladder diagram 200 illustrating use of the cloud tape library system 100 for data storage and retrieval according to aspects of the present disclosure. Ladder diagram 200 illustrates creation of a user-specific virtual cloud tape library (CTL) (section 220), writing data to the cloud tape library (section 250), and reading data from the cloud tape library (section 280).

Data storage in a cloud tape library may begin with the creation of a user-specific virtual cloud tape library (section 220). In some examples, the user specific cloud tape library may be associated with a specific user account. In other examples the user specific cloud tape library may be associated with one or more user devices 102.

At step 222, a user device 102 may establish a connection with management server 106. Establishing a connection may include authenticating access to the management server 106. The user device 102 may connect to the management server 106 via software on the user device 102 configured to create, connect to, send data to, receive data from, and/or manage a cloud tape library. In other examples, the connection may be established via a web browser or command line interface (CLI). The user device 102 may establish an account with the management server 106 and create/generate user credentials for user authentication, send payment information, etc. The user device 102 may log into the management server 106 (with, e.g., credentials established at account creation).

The user device 102 may send a request to the management server 106 to create a cloud tape library (step 224). The request may include parameters including a cloud tape library name, a storage size (e.g., an amount of storage/number of tapes to reserve), a location (e.g. of a tape library 110 to store data in) or selection of a particular tape library, and/or dual/single copy (data mirroring on multiple tapes/tape libraries), etc. The request may also include the type of tape cartridge to use (e.g., read/write or WORM) and whether to compress and/or encrypt data stored in the CTL and the type of compression/encryption.

In some examples, in order to control how to organize the data written for a fast retrieval, the user can set rules for data organization based on the Cloud Tape Library name, which may be translated to the name of the storage data structure (by, e.g., the disk caching layer 108); the file extension/data type; file permissions; and user defined tags. These rules and the relevant metadata may be used by the disk caching layer 108 to determine, in real time, which tape cartridges to write the data and which tape cartridges to retrieve the data from. The user device 102 may send the set of data organization rules with the request to create the cloud tape library.

The management server 106 may manage multiple physical tape libraries (including tape library 110) based in multiple locations. The management server 106 may determine which tape library 110/disk cache layer 18 to send the request to create the cloud tape library for the user device 102. The determination may be based on information from the request of the user device 102 (e.g., location information, tape library selection, etc.). In some examples, a user device 102/user account may create/control multiple cloud tape libraries, e.g., in multiple locations. The user device 102 may control all cloud tape libraries via the management server 106.

In response to the request from the user device 102 (at step 224), the management server 106 may send an instruction to create a storage data structure at the disk cache layer 108 (step 226). The request may include data structure parameters to create/initialize the storage data structure. Data structure parameters may include information about the user account/user device 102 to associate with the data structure or any data from the request of the user device 102 (including, e.g., a storage size to allocate, cloud tape library name, etc.), or other data from the management server 106.

In response to the instruction from the management server 106 (at step 226), the disk cache layer 108 may create the storage data structure (step 228). The storage data structure may include a container for data (e.g., objects, files, etc.) to be stored in the cloud tape library. The storage data structure may include metadata including access controls, user permissions (e.g., read/write permissions), location information, etc.

In one example, the storage data structure may include a Simple Storage Service (S3) bucket with the name of the CTL. Each Cloud Tape Library may be correlated with an S3 bucket in the disk caching layer 108. One or more tape libraries 110 may use/have a disk caching layer 108 (or other front-end disk-based cache solution) that exposes S3 buckets to the user device 102. User devices 102 may interact with the CTL via an Application Programming Interface (API), e.g., the S3 API.

The disk caching layer 108 may instruct the tape library 110 to allocate a number of tape cartridges to the storage data structure (step 230). The disk caching layer 108 may determine the number of tapes to allocate based on the amount of storage requested by the user device 102, storage size(s) of unallocated tapes, etc. The instruction may include a number of tapes to allocate or an amount of storage to allocate (and the tape library 110 determines which/how many tape cartridges to allocate to the storage data structure).

In response to receiving the instruction to allocate tape cartridges from the disk caching layer 108, the tape library 110 may allocate tape cartridges to the storage data structure (step 232). The tape library 110 may send identifying information about the allocated tape cartridge(s), e.g., serial number(s) of the allocated tape cartridge(s).

In response to receiving the identifying information from the tape library 110, the disk cache layer 108 may assign the serial numbers/identifying information of the tape cartridges to the storage data structure (step 234). The disk cache layer 108 may generate or assign a Uniform Resource Locator (URL) (or other address) to access/read/write to the storage data structure/CTL. The user device 102 may interact directly with the storage data structure/CTL via the URL (via, e.g., the API). The disk caching layer 108 may send the URL to the management server 106. The management server 106 may provide the URL to the user device 102 (step 236).

The management server 106 may generate one or more keys (or other security credentials) to access the CTL (by e.g., the user device 102). In some examples, the keys may include an access key identifier (or a username credential) and a secret access key (or a password credential) key pair. The key pair may be used to access the CTL via an API. The keys may be generated based on the creation of the storage data structure (at the disk caching layer 108) or via a separate user request (via the user device 102). The management server 106 may send the generated keys/credentials to the user device 102 and the disk caching layer 108.

In response to receiving the keys from the management server (at step 238), the disk caching layer 108 may assign the keys to the storage data structure creating the CTL (step 240). The user device 102 may write and read data to the CTL (via e.g., API commands) using the URL and keys to authenticate access of the write/read request with the disk caching layer 108. The CTL may be ready to accept data directly from the user.

Each user's data is stored on dedicated (physical) tape cartridges, ensuring complete isolation from other user's data and greater security as data from multiple users are not interspersed on the same tape cartridge. Users may secure their data with their own encryption keys, providing robust encryption capabilities. As the tape cartridges are dedicated to a particular user, users may maintain sovereignty over their information. Users may request that one or more of their tape cartridges be ejected from the tape library 110 and returned to them, be used in another tape library, and/or destroyed. For example, users may request and receive the tape cartridges with the customer's data (e.g., at the end of the service period) as the data stored on the tape cartridge is dedicated to the user (to the exclusion of other users of the CTL system). In other shared systems, the system may need to copy the user data to other media devices (e.g. tape cartridge/hard disk/etc.) upon a user request of their data on a physical media. The CTL system may not need to perform that additional data transfer to write the user data to another storage media to send the storage media to the user as the media is dedicated to user data.

A user may want to write data to the CTL (section 250). A user device 102 may write data to the CTL in batches (e.g., periodically at a particular period of time) or in bursts (e.g., as data is generated). The user device 102 may send a write request to the CTL (step 252). The user may send the request to the CTL (directly) as one or more tape libraries (including the tape library 110) may have an associated disk caching layer 108 (e.g. a front-end disk-based cache) that exposes the storage data structure (e.g., a container/S3 bucket) to the user. Each CTL may be associated with the storage data structure in the disk caching layer 108. When data is written to the storage data structure, the data is written to hard disk drive storage (or other random access storage) at the disk caching layer 108 prior to storage in on tape cartridges at the tape library 110. In this manner, multiple users may write data in parallel to different storage data structures/CTLs. Writing by multiple users may be despite a limited number of drives on the tape library 110, e.g., fewer than the number of CTLs being written to or stored on the tape library 110.

The request be sent to (or include) the URL of the CTL/storage data structure. The request may include the assigned keys. In some examples, the write request may be via an API request directly to the disk caching layer 108 (e.g., bypassing an intermediary system such as the management server 106). The user device 102 may send user data to the CTL (e.g., following the establishment of a connection with the CTL/disk caching layer 108).

In response to the write request and/or receiving the user data, the disk caching layer 108 may cache the user data prior to storage on the tape library 110 (step 254). The disk caching layer 108 may write the data to a hard disk drive (or other random access storage media) to cache the user data.

In response to receiving the user data, disk caching layer 108 may return an acknowledgement to the user device 102 (step 256). The acknowledgement may be returned following caching the user data but prior to storage of the user data on the tape library 110 (in the tape cartridges associated with the CTL).

The disk caching layer 108 may compress the user data to reduce the storage size on the tape cartridges and/or encrypt the user data for privacy and security of the user data. The user may select compression or encryption options when creating the CTL or when requesting to store the user data. Encryption may be performed at the file level or at the storage level (e.g., the entire tape cartridge). Encryption algorithms that may be used to encrypt include symmetric (e.g., Advanced Encryption Standard (AES), Data Encryption Standard (DES)/triple DES, etc.) and asymmetric encryption (e.g., RSA, etc.) algorithms.

At some point, e.g., at a predetermined time (e.g., based on a predetermined time threshold) after the last write from a particular user, the disk caching layer 108 destages/sends the data to the tape library 110. The disk caching layer 108 may determine which tape cartridge to store the user data to on in the tape library 110 (step 258). The disk caching layer 108 may use data associated with the storage data structure (and/or other metadata information) to select the tape cartridge to use for storage. For example, where there is a single tape cartridge (or a single tape cartridge with free storage space) associated with the CTL/storage data structure, the disk caching layer 108 may select that tape cartridge based on the identified CTL/storage data structure associated with the user request (sent at step 252).

In other examples, multiple tape cartridges (or multiple tape cartridges with free storage space) may be associated with a CTL/storage data structure. In such examples, user data (associated with the same user) may be stored in different tape cartridges based on multiple parameters. The disk caching layer 108 may perform a look-up to a set of data organizational rules associated with the CTL or user account to determine the tape. The data organization rules may be set by the user (e.g., at the creation of the CTL or modified by the user after the creation of the CTL). The data organization rules may include a set of parameters for organizing the data. Parameters may include metadata information associated with (or other attribute of) the user data. For example, the user request may include the name of the CTL/storage data structure. Where a CTL name is provided, the disk caching layer 108 may translate the CTL name into the name of the storage data structure (e.g., a bucket name) for use as a parameter. Other parameters may include attributes of the file/data (e.g., file extension/type, or file permissions). Parameters may also include one or more tags assigned to the data, by e.g., the user device 102 and sent to the disk caching layer 108. Tags may include the purpose of the data, project information, division information of an organization, etc.

In some examples, the disk caching layer 108 (or the tape library 110) may store the user data in the next available free location on the tape cartridge. In other examples, a single tape cartridge allocated to a user/CTL may include different physical locations on the tape cartridge allocated for different purposes. The disk caching layer 108 may determine both the tape cartridge to mount and the location on the tape cartridge to store the user data. The disk caching layer 108 may and send both data associated with the tape cartridge to the tape library 110 to mount the selected tape cartridge and a location on the tape cartridge to begin write (or read) operations.

In this manner, the user has control over how to organize the data on the tape cartridges. Such organization may optimize later reads of the data and associated data due to the physical proximity (e.g., the same tape cartridge, sequential storage on the tape cartridge, etc.).

In some examples, requests to read and write data may be received from multiple user devices. The disk caching layer 108 may arbitrate and prioritize requests. For example, the disk caching layer 108 may prioritize read requests by caching data to be written to the tape library while there are pending read requests. Alternatively, write requests may be given priority and cached data may be written to the tape library 110 before requests to retrieve data from the tape library 110. In one example, the disk caching layer 108 may be configured to complete a request once the disk caching layer 108 begins handling a read/write operation (e.g., once an instruction to mount the selected tape is sent to the tape library 110 or data is transferred to/from the tape library 110).

The disk caching layer 108 may determine the availability of a tape drive in the tape library 110 to mount the selected tape cartridge (step 260). The disk caching layer 108 may wait for an available tape drive in the tape library 110 (step 262) (e.g., when no tape drive is currently available in the tape library 110). In some examples, determining the availability of a tape drive may be based on a response from the tape library 110 to a status request sent by the disk caching layer 108. In examples where a status is requested by the disk caching layer 108, the disk caching layer 108 may wait a predetermined period of time before requesting further status (step 260) and then continuing to wait (step 262). In other examples, determining tape drive availability may be based on the disk caching layer 108 receiving an indication of the completion of a prior write/read operation from the tape library 110. In further examples, the disk caching layer 108 instructs the tape library 110 to mount the tape cartridge to a tape drive and waits for a response from the tape library 110 to begin sending data.

Once a tape drive is available in the tape library 110, the disk caching layer 108 may instruct the tape library 110 to load/mount the selected tape cartridge (step 264). In response to the instruction, the tape library 110 may mount the selected tape (step 266). The tape library 110 may move the selected tape cartridge to a particular position on the selected tape (e.g., the next available location or a position indicated by the disk caching layer 108). In response to mounting the selected tape, the tape library 110 may send an acknowledgement message to the disk caching layer 108. The acknowledgement message may indicate that the selected tape is mounted and/or the tape library 110 is ready to receive/write the user data.

The disk caching layer 108 may send the user data to the tape library 110 for storage on the selected tape (step 268). Sending the user data to the tape library may be based on receiving the acknowledgement message. In response to receiving the user data, the tape library 110 may write the user data to the selected tape cartridge (step 270). The tape library 110 may write the user data to a selected position on the tape cartridge.

A user may want to read/retrieve data from the CTL (section 280). The user device 102 may send a read request/command (via, e.g., an S3 API call) to read from a particular CTL/storage data structure (e.g., a bucket) (step 282). The user may send the request to the CTL (directly) as one or more tape libraries (including the tape library 110) may have an associated disk caching layer 108 (e.g. a front-end disk-based cache) that exposes the storage data structure (e.g., a container/S3 bucket) to the user. The request may be sent to (or include) a URL associated with the CTL. The request may be received by the disk caching layer 108. Each CTL may be correlated with the storage data structure in the disk caching layer 108. When data is read from the storage data structure, in some examples the data from the tape library 110 is cached on the disk caching layer 108 before sending it to the user device 102. In these examples, the data is written to hard disk drive storage (or other random-access storage) at the disk caching layer 108 prior to sending the data to the user device 102. In other examples, the data from the tape library 110 is sent to the user without prior caching (e.g., bypassing the disk caching layer 108).

The disk caching layer 108 may determine from which tape cartridge to retrieve the user data in the tape library 110 (step 284). The disk caching layer 108 may use data associated with the storage data structure (and/or other metadata information) to select the tape cartridge to use for storage. For example, where there is a single tape cartridge associated with the CTL/storage data structure, the disk caching layer 108 may select that tape cartridge based on the identified CTL/storage data structure associated with the user request (sent at step 282).

In other examples, multiple tape cartridges (or multiple tape cartridges with free storage space) may be associated with a CTL/storage data structure. In such examples, user data (associated with the same user) may be stored in different tape cartridges based on multiple parameters. The disk caching layer 108 may perform a look-up to a set of data organizational rules associated with the CTL or user account to determine the tape to read from. The data organization rules may be set by the user (e.g., at the creation of the CTL or modified by the user after the creation of the CTL). The data organization rules may include a set of parameters for organizing the data. Parameters may include metadata information associated with (or other attribute of) the user data. For example, the user request may include the name of the CTL/storage data structure. Where a CTL name is provided, the disk caching layer 108 may translate the CTL name into the name of the storage data structure (e.g., a bucket name) for use as a parameter. Other parameters may include attributes of the file/data (e.g., file extension/type, or file permissions). Parameters may also include one or more tags assigned to the data, by e.g., the user device 102 and sent to the disk caching layer 108. Tags may include the purpose of the data, project information, division information of an organization, etc.

The disk caching layer 108 may determine the availability of a tape drive in the tape library 110 to mount the selected tape cartridge (step 286). The disk caching layer 108 may wait for an available tape drive in the tape library 110 (step 290). In some examples, determining the availability of a tape drive may be based on a response from the tape library 110 to a status request sent by the disk caching layer 108. In examples where a status is requested by the disk caching layer 108, the disk caching layer 108 may wait a predetermined period of time before requesting further status (step 288) and then continuing to wait (step 290). In other examples, determining tape drive availability may be based on the disk caching layer 108 receiving an indication of the completion of a prior write/read operation from the tape library 110. In further examples, the disk caching layer 108 instructs the tape library 110 to mount the tape cartridge to a tape drive and read/send data and waits for the tape library 110 to send the data.

Once a tape drive is available in the tape library 110, the disk caching layer 108 may instruct the tape library 110 to load/mount the selected tape cartridge (step 288). In response to the instruction, the tape library 110 may mount the selected tape (step 292). A retrieval assembly (e.g., a robot) may remove a tape from the drive in the tape library 110 and return the tape to the tape cartridge storage. The retrieval assembly may retrieve the selected tape cartridge from a tape cartridge storage within the tape library 110 and insert the tape cartridge into the drive of the tape library 110. The drive may move the selected tape cartridge to a particular position. In response to mounting the selected tape cartridge, the tape library 110 may send an acknowledgement message to the disk caching layer 108. The acknowledgement message may indicate that the selected tape cartridge is mounted and/or the tape library 110 is ready to receive the user data.

The disk caching layer 108 may send a request/instruction to read the requested user data from the selected tape of the tape library 110 (step 294). The tape library 110 may read the data from the selected tape and send the requested data (step 296). In some examples, the data may be sent to the disk caching layer 108. The disk caching layer 108 may write the received data to memory/disk (e.g., random-access storage/hard disk drive) and then return the data to the user device 102 (step 298). In other examples, the data may be sent from the tape library 110 to the user device 102 (bypassing the disk caching layer 108). Where the requested data was compressed or encrypted, the disk caching layer 108 may decompress and/or decrypt the user data before returning the data to the user.

### Disk Caching Layer

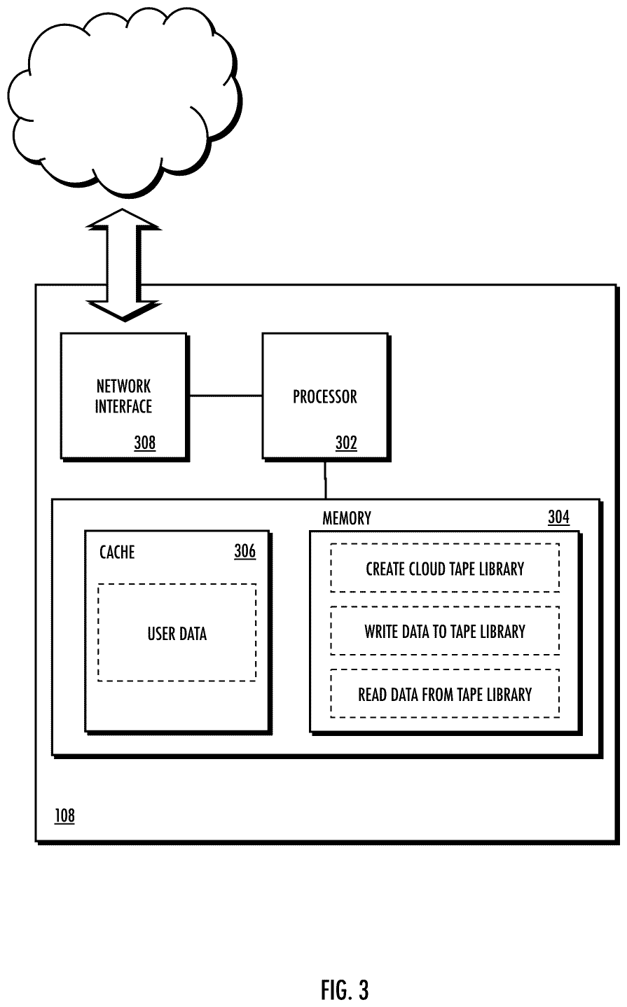

FIG. 3 is a logical block diagram of a disk caching layer 108, according to aspects of the present disclosure. The disk caching layer 108 includes a processor subsystem 302 (including a central processing unit (CPU) and/or a graphics processing unit (GPU)), a memory subsystem 304 (including a cache subsystem 306), a network/data interface subsystem 308, and a bus to connect them. The disk caching layer 108 may be connected and send data to/receive data from user devices 102, a management server 106, and/or a tape library 110 via a network 104. During operation, an application running on the disk caching layer 108, creates, writes to, and reads data from a tape library 110. In one exemplary embodiment, the disk caching layer 108 may be a computer system that cache, process, and send data between user devices 102 and a tape library 110. Some examples of disk caching layers may include without limitation: a workstation, a server, and/or any other computing device. In other examples, the disk caching layer 108 may be a portion of the tape library 110.

In one embodiment, the processor subsystem 302 may read instructions from the memory subsystem and execute them within one or more processors. In one specific implementation, the CPU controls device operation and/or performs tasks of arbitrary complexity/best-effort. CPU operations may include, without limitation: operating system (OS) functionality (power management, UX), memory management, etc. Other processor subsystem implementations may multiply, combine, further subdivide, augment, and/or subsume the foregoing functionalities within these or other processing elements. GPUs may be used to perform high complexity operations in parallel.

In one embodiment, the network/data interface subsystem 308 may be used to receive data from, and/or transmit data to, other devices. In some embodiments, data may be received/transmitted as transitory signals (e.g., electrical signaling over a transmission medium). In other embodiments, data may be received/transmitted as non-transitory symbols (e.g., bits read from non-transitory computer-readable media). The network/data interface subsystem 308 may include: wired interfaces, wireless interfaces, and/or removable memory media. In one exemplary embodiment, the network/data interface subsystem 308 may include network interfaces including, but not limited to: Wi-Fi, Bluetooth, Global Positioning System (GPS), USB, and/or Ethernet network interfaces. Additionally, the network/data interface subsystem 308 may include removable media interfaces such as: SD cards (and their derivatives) and/or any other optical/electrical/magnetic media (e.g., MMC cards, CDs, DVDs, tape, etc.).

The memory subsystem 304 may be used to store (write) data locally at the disk caching layer 108. In one exemplary embodiment, data may be stored as non-transitory symbols (e.g., bits read from non-transitory computer-readable media). In one specific implementation, the memory subsystem 304 is physically realized as one or more physical memory chips (e.g., NAND/NOR flash) that are logically separated into memory data structures. The memory subsystem 304 may be bifurcated into program code and/or program data. Additionally, memory subsystem 304 may include cache subsystem 306. Cache subsystem includes one or more random-access storage devices (e.g., hard disk drives, solid state drives, etc.) configured to store and process data for storage on and retrieval from the tape library 110.

In one embodiment, the program code includes non-transitory instructions that when executed by the processor subsystem cause the processor subsystem to perform tasks which may include: calculations, storage of data on the cache subsystem 306, processing cached data, and/or control of the network/data interface subsystem 308. In some embodiments, the program code may be statically stored within the disk caching layer 108 as firmware. In other embodiments, the program code may be dynamically stored (and changeable) via software updates. In some such variants, software may be subsequently updated based on various access permissions and procedures. In one embodiment, the tasks are configured to: create, write data to, and read data from a tape library 110.

Still other variants may be substituted with equal success by artisans of ordinary skill, given the contents of the present disclosure.

### Tape Library

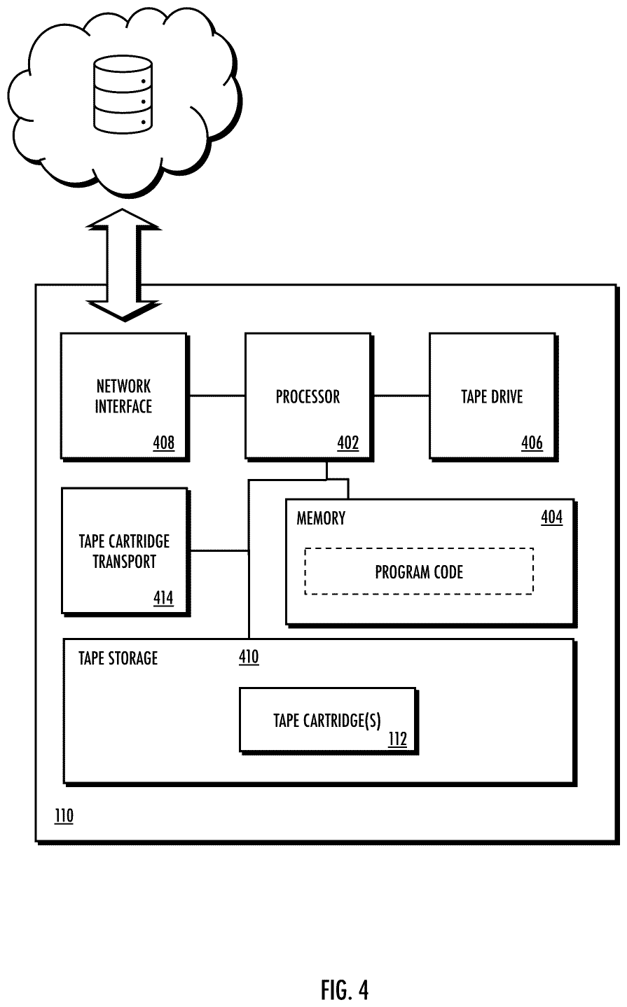

FIG. 4 is a logical block diagram of a tape library 110, according to aspects of the present disclosure. The tape library 110 includes a processor subsystem 402 (including a central processing unit (CPU) and/or a graphics processing unit (GPU)), a memory subsystem 404, tape drives 406 a network/data interface subsystem 408, tape storage 410 (with tape cartridges 112), tape cartridge transport subsystem 414, and a bus to connect them. The tape library 110 may be connected and send data to/receive data from a disk caching layer 108 and/or user devices 102, a management server 106, etc. via a network 104. During operation, an application running on the tape library 110 retrieves tape cartridges 112 from tape storage 410 via the tape cartridge transport subsystem 414, mounts the tape cartridges 112 into the tape drive(s) 406, read/writes data to the tape cartridges 112, unmounts the tape cartridges 112 from the tape drive(s) 406, and returns the tape cartridges 112 to the tape storage 410 via the tape cartridge transport subsystem 414. In one exemplary embodiment, the disk caching layer 108 may be a computer system that read and write data to multiple tapes. In some examples, the tape library 110 may include the disk caching layer 108.

In one embodiment, the processor subsystem 402 may read instructions from the memory subsystem and execute them within one or more processors. In one specific implementation, the CPU controls device operation and/or performs tasks of arbitrary complexity/best-effort. CPU operations may include, without limitation: operating system (OS) functionality (power management, UX), memory management, etc. Other processor subsystem implementations may multiply, combine, further subdivide, augment, and/or subsume the foregoing functionalities within these or other processing elements. GPUs may be used to perform high complexity operations in parallel.

In one embodiment, tape drive 406 may mount/unmount (e.g., eject) tape cartridges 112 and read and write data to tape cartridges 112. Tape drive 406 may include read/write heads that magnetically encode and retrieve data from the tape cartridges 112. Tape drive 406 may include capstan/motors that control the movement of the tape within the tape cartridges 112 and a reel system to wind and unwind the tape inside the tape cartridge.

In one embodiment, the network/data interface subsystem 408 may be used to receive data from, and/or transmit data to, other devices. In some embodiments, data may be received/transmitted as transitory signals (e.g., electrical signaling over a transmission medium). In other embodiments, data may be received/transmitted as non-transitory symbols (e.g., bits read from non-transitory computer-readable media). The network/data interface subsystem 408 may include: wired interfaces, wireless interfaces, and/or removable memory media. In one exemplary embodiment, the network/data interface subsystem 308 may include network interfaces including, but not limited to: Wi-Fi, Bluetooth, Global Positioning System (GPS), USB, and/or Ethernet network interfaces. Additionally, the network/data interface subsystem 408 may include removable media interfaces such as: SD cards (and their derivatives) and/or any other optical/electrical/magnetic media (e.g., MMC cards, CDs, DVDs, tape cartridges, etc.).

In one embodiment, tape storage 410 may include dedicated compartments designed to securely hold individual tape cartridges 112 when they are not in use. These compartments may be arranged in rows or columns within a chassis of the tape library 110. The tape storage 410 may optimize space for efficient storage and retrieval. Each compartment may be aligned to allow retrieval by the tape cartridge transport subsystem 414 to transport tape cartridges 112 between the compartments and the tape drives 406.

In one embodiment, tape cartridge transport subsystem 414 may be configured to locate, retrieve, transport, and insert tape cartridges 112 between their designated storage slots in tape storage 410, tape drives 406, and import/export slots of the tape library without human intervention. A robotic arm/transport robot may be used to ensure that tape cartridges 112 are securely gripped and moved to the correct position within the tape library 110. The robotic arm may include a gripping mechanism, a rotating base, and a vertical/horizontal track system that allows it to navigate the tape library 110. The gripping mechanism may securely hold tape cartridges 112 using either mechanical clamps or vacuum suction, ensuring that tape cartridges 112 do not slip or get damaged during transport. The robotic arm may move along a track that spans the height and width of the tape library 110. The tape cartridge transport subsystem 414 may include a scanning system (e.g., barcode/RFID scanning system) to track tape cartridges 112.

The memory subsystem 404 may be used to store (write) data locally at the tape library 110. In one exemplary embodiment, data may be stored as non-transitory symbols (e.g., bits read from non-transitory computer-readable media). In one specific implementation, the memory subsystem 404 is physically realized as one or more physical memory chips (e.g., NAND/NOR flash) that are logically separated into memory data structures. The memory subsystem 404 may be bifurcated into program code and/or program data.

In one embodiment, the program code includes non-transitory instructions that when executed by the processor subsystem cause the processor subsystem 402 to perform tasks which may include: calculations, receive and send instructions and data via the network/data interface subsystem 408; locate, mount, and return tape cartridges 112 between tape storage 410 and tape drive 406 by operating tape cartridge transport subsystem 414, reading data from and writing data to tape cartridges by operating the tape drives 406, and/or control of the network/data interface subsystem 408. In some embodiments, the program code may be statically stored within the tape library 110 as firmware. In other embodiments, the program code may be dynamically stored (and changeable) via software updates. In some such variants, software may be subsequently updated based on various access permissions and procedures.

Still other variants may be substituted with equal success by artisans of ordinary skill, given the contents of the present disclosure.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method of archiving data, comprising:
receiving first user data associated with a first user and second user data associated with a second user, the second user different than the first user;
caching the first user data and the second user data;
writing the first user data to a first user specific tape in a tape library; and
writing the second user data to a second user specific tape in the tape library, the second user specific tape different from the first user specific tape.

2. The method of claim 1, where:
receiving the first user data comprises receiving a first request to store the first user data in a first storage data structure associated with the first user from a first user device, and
receiving the second user data comprises receiving a second request to store the second user data in a second storage data structure associated with the second user from a second user device.

3. The method of claim 2, further comprising sending an acknowledgement message to the first user device in response to caching the first user data prior to writing the first user data to the first user specific tape in the tape library.

4. The method of claim 1, where caching the first user data and the second user data comprises:
storing the first user data and the second user data in a hard disk drive,
removing the first user data from the hard disk drive in response to writing the first user data to the first user specific tape in the tape library, and
removing the second user data from the hard disk drive in response to writing the second user data to the second user specific tape in the tape library.

5. The method of claim 1, determining to store the first user data to the first user specific tape of a plurality of tapes associated with the first user in the tape library.

6. The method of claim 5, where determining to store the first user data to the first user specific tape is based on an attribute of the first user data.

7. The method of claim 5, further comprising receiving a first request to store the first user data, the first request comprising one or more user assigned tags assigned to the first user data, where determining to store the first user data to the first user specific tape is based on the one or more user assigned tags.

8. The method of claim 1, where writing the first user data to the first user specific tape comprises:
determining availability of a tape drive in the tape library;
instructing the tape library to mount the first user specific tape; and
sending the first user data to the tape library for storage in the first user specific tape.

9. The method of claim 1, further comprising determining a threshold of time has elapsed since a last write from the first user, where writing the first user data to the first user specific tape comprises is based on determining the threshold of time has elapsed.

10. The method of claim 1, where the first user data and the second user data is received in parallel and writing the first user data to the first user specific tape occurs prior to writing the second user data to the second user specific tape.

11. An apparatus for retrieving archived data, comprising:
a processor;
a non-transitory computer-readable medium comprising instructions that when executed by the processor, cause the processor to:
receive a request for data from a user device associated with a first user account of a plurality of user accounts;
determine a tape of a plurality of tapes in a tape library to retrieve the data, the tape exclusively associated with the first user account of the plurality of user accounts;
determine an availability of a tape drive of the tape library to mount the tape;
instruct the tape library to mount the tape;
receive the data from the tape library; and
send the data to the user device.

12. The apparatus of claim 11, where the instructions, when executed by the processor, further cause the processor to store the data received from the tape library on the apparatus prior to sending the data to the user device.

13. The apparatus of claim 11, where:
a second plurality of tapes of the plurality of tapes in the tape library are exclusively associated with the first user account of the plurality of user accounts, and
determining the tape of the plurality of tapes to retrieve the data is based on at least one of a file type of the data, file permissions of the data, and a user defined tag associated with the data.

14. The apparatus of claim 13, where determining the tape of the plurality of tapes to retrieve the data comprises performing a lookup of a set of data organization rules associated with the first user account.

15. The apparatus of claim 11, where the instructions, when executed by the processor, further causes the processor to:
receive a second request for second data from a second user device associated with a second user account of the plurality of user accounts, where the second user account is different from the first user account;
determine a second tape of the plurality of tapes in the tape library to retrieve the second data, the second tape exclusively associated with the second user account of the plurality of user accounts;
determine a second availability of the tape drive of the tape library;
wait while the tape drive in the tape library is unavailable based on the second availability;
instruct the tape library to mount the second tape in response to the tape drive being available;
receive the second data from the tape library; and
send the second data to the second user device.

16. A method for creating a cloud tape library comprising:
receiving first user account information, where the first user account information is associated with a first user account;
creating a first storage data structure associated with the first user account information;
assigning one or more tape cartridges of a tape library to the first storage data structure, the one or more tape cartridges associated with the first user account; and
returning access information associated with the first storage data structure.

17. The method of claim 16, further comprising assigning access keys to the first storage data structure.

18. The method of claim 16, where assigning the one or more tape cartridges to the first storage data structure comprises:
sending a number of tapes to allocate to the tape library based on the first user account information; and
receiving identifiers associated with each of the number of tapes from the tape library.

19. The method of claim 16, further comprising receiving a set of data organization rules configured to determine a placement of data onto the one or more tape cartridges.

20. The method of claim 19, where the set of data organization rules are based on at least one of a cloud tape library name, a file type, a file permission, and a user defined tag.
